(19) United States
(12) Patent Application Publication
(10) Pub. No.: US 2008/0311020 A1
(43) Pub. Date: Dec. 18, 2008

(54) Method for Producing High Purity Silicon

(75) Inventors: Nobuaki Ito, Chiba (JP); Jiro Kondo, Chiba (JP); Kensuke Okazawa, Chiba (JP); Masaki Okajima, Chiba (JP)

Correspondence Address: BIRCH STEWART KOLASCH & BIRCH, PO BOX 747, FALLS CHURCH, VA, 22040-0747, US

(73) Assignee: NIPPON STEEL MATERIALS CO., LTD., TOKYO (JP)

(21) Appl. No.: 11/885,798

(22) PCT Filed: Feb. 28, 2006
(86) PCT No.: PCT/JP2006/304201

§ 371 Date: May 23, 2008

(30) Foreign Application Priority Data
Mar. 7, 2005 (JP) 2005-062560
Feb. 10, 2006 (JP) 2006-034362

(51) Int. Cl. C01B 33/037

(52) U.S. Cl. 423/349

(57) ABSTRACT

An object of the invention is to provide a method for producing a large amount of inexpensive and high purity silicon useful in a solar battery. The method includes steps of preparing molten silicon, preparing a slag, bringing the molten silicon and the slag into contact with each other, and exposing at least the slag to vacuum pressure.

This application claims priority to Japanese patent application No. 2005-062560, filed in Japan on Mar. 7, 2005, and Japanese patent application No. 2006-034362, filed in Japan on Feb. 10, 2006, the entire contents of which are herein incorporated by reference.

### BACKGROUND OF THE INVENTION

1. Field of the Invention

The present invention relates to a method for producing high-purity silicon. The high-purity silicon is used for a solar battery.

2. Description of the Related Art

As for silicon to be used for a solar battery, the purity has to be 99.9999 mass % or more, each of the metallic impurities in the silicon is required to be not more than 0.1 mass ppm. Especially, the impurity of boron (B) is required to be not more than 0.3 mass ppm. Although silicon made by the Siemens Process, which is used for a semiconductor, can meet the above requirements, the silicon is not suitable for a solar battery. This is due to the fact that the manufacturing cost of silicon by the Siemens Process is high while a solar battery is required to be inexpensive.

Several methods have been presented in order to produce high-purity silicon at a low cost.

The process of unidirectional solidification of silicon metal has been well known for a long time. In such a process, molten silicon metal is unidirectionally solidified to form a more purified solid phase silicon utilizing the difference in solubility of impurities between solid phase and liquid phase. Such a process can be effectively used for purifying silicon from a variety of metallic impurities. However, this method cannot be used for purifying silicon from boron because the difference in solubility of boron between solid phase and liquid phase is too small to purify silicon from boron.

The process of vacuum melting silicon is also well known. This process removes low boiling point impurities from silicon by holding molten silicon in a vacuum state and is effective to remove carbon impurities from silicon. However, this method cannot be applied to purifying silicon from boron because boron in molten silicon does not normally form a low boiling point substance.

As mentioned above, boron has been thought to be a problematic component because boron in silicon is the most difficult impurity to removed from and yet greatly affects the electrical property of silicon. Methods for which the main purpose is to remove boron from silicon are disclosed as follows.

JP56-32319A discloses a method for cleaning silicon by acid, a vacuum melting process for silicon and a unidirectional solidification process for silicon. Additionally, this reference discloses a purification method using slag for removing boron, where the impurities migrate from the silicon to the slag, which is placed on the molten silicon. In the patent reference JP56-32319A, the partition ratio of boron (concentration of boron in slag/concentration of boron in silicon) is 1.357 and the obtained concentration of boron in the purified silicon is 8 mass ppm by using slag including (CaF₂+CaO+SiO₂). However, the concentration of boron in the purified silicon does not satisfy the requirement of silicon used for solar batteries. The disclosed slag purification cannot industrially improve the purification of silicon from boron because the commercially available raw material for the slag used in this method always contains boron on the order of several ppm by mass and the purified silicon inevitably contains the same level of boron concentration as in the slag unless the partition ration is sufficiently high. Consequently, the boron concentration in the purified silicon obtained by the slag purification method is at best about 1.0 mass ppm when the partition ratio of boron is 1.0 or so. Although it is theoretically possible to reduce the boron concentration by purifying the raw materials for the slag, this is not industrially feasible because it is economically unreasonable.

JP58-130114A discloses a slag purification method, where a mixture of ground crude silicon and slag containing alkaline-earth metal oxides and/or alkali metal oxides are melted together. However, the minimum boron concentration of the obtained silicon is 1 mass ppm, which is not suitable for a solar battery. In addition, it is inevitable that new impurities are added when the silicon is ground, which also makes this method inapplicable to solar batteries.

Non-patent reference, “Shigen to Sozai” (Resource and Material) 2002, vol. 118, p. 497-505, discloses another example of slag purification where the slag includes (Na₂O+CaO+SiO₂) and the maximum partition ratio of boron is 3.5. The partition ratio 3.5 is the highest value disclosed in the past, however, this slag purification is still inapplicable to solar batteries considering the fact that the boron concentration in the practically available raw material of slag.

As mentioned above, conventional slag purification methods, which fail to obtain a practically available high partition ratio of boron, are not suitable for obtaining silicon useful in a solar battery. The reason why the partition ratio of boron, when purifying silicon from boron, tends to be low is that silicon is oxidized as easily as boron. In slag purification methods, boron in silicon tends to be non-oxidized and the non-oxidized boron is hardly absorbed in the slag. The slag purification method is widely used for removing boron from steel because boron is far more easily oxidized than steel. Because of the essential difference in properties between steel and silicon, the slag purification technique in steel industry cannot simply be applied to removing boron from silicon.

Methods combining conventional slag purification and other methods are presented.

JP2003-12317A discloses another purification method. In this method, fluxes such as CaO, CaO₃ and Na₂O are added to silicon and they are mixed and melted. Then, blowing oxidizing gas into the molten silicon results in purification. However, silicon purified by this method has a boron concentration of about 7.6 mass ppm, which is not suitable for use in a solar battery. Furthermore, it is difficult, from an engineering point of view, to blow stably oxidizing gas into molten silicon at low cost. Therefore, the method disclosed in JP2003-12317A is not suitable for the purification of silicon.

U.S. Pat. No. 5,972,107 and U.S. Pat. No. 6,368,403 disclose methods for purifying silicon from boron where a special torch is used and water vapor and SiO₂ are supplied in addition to oxygen and hydrogen and CaO, BaO and/or CaF₂ to molten silicon.

The technologies in U.S. Pat. No. 5,972,107 and U.S. Pat. No. 6,368,403, requiring not only expensive equipments such as a special torch but also a complicated operation, are difficult to implement from an industrial point of view.

The conventional technologies mentioned above can be classified into two categories. The first category includes methods where slag only is supplied onto molten silicon (disclosed in JP56-32319A and JP58-130114A, hereinafter referred to as “simple slag purification method”). The second category includes methods where oxidizing gas is contacted with the molten silicon and slag and/or raw materials of slag such as SiO₂ are supplied onto molten silicon (disclosed in JP2003-12317A, U.S. Pat. No. 5,972,107 and U.S. Pat. No. 6,368,403, hereinafter referred to as “complex slag purification method”). The present inventors have presented another method for purifying silicon from boron in WO2005/085134A1.

### SUMMARY OF THE INVENTION

An object of the present invention is to provide a method of producing high purity silicon simply at low cost by purifying crude silicon from impurities, particularly boron, to a level useful for solar batteries.

The present inventors have designed the following solutions after studying silicon production.

A first embodiment is a method for producing high purity silicon comprising: preparing molten silicon, preparing a slag, bringing the molten silicon and the slag into contact with each other, and exposing at least the slag to vacuum pressure.

A second embodiment is a method for producing high purity silicon comprising: preparing molten silicon, preparing a slag, bringing the molten silicon and the slag into contact with each other, separating the slag from the molten silicon, exposing the slag to vacuum pressure, and bringing the molten silicon and the slag exposed to the vacuum pressure into contact with each other.

A third embodiment is a method according to the first embodiment or the second embodiment, further comprising: providing an oxidizing agent together with the slag to the molten silicon.

A fourth embodiment is a method according to the third embodiment, wherein the oxidizing agent is provided so as to directly contact the molten silicon.

A fifth embodiment is a method according to the first embodiment or the second embodiment, wherein the vacuum pressure ranges from 10 Pa to 10,000 Pa.

A sixth embodiment is a method according to the third embodiment, wherein the oxidizing agent is a material comprising as a primary component at least one of the following materials: alkali metal carbonate hydrate of alkali metal carbonate, alkali metal hydroxide, alkaline-earth metal carbonate, hydrate of alkaline-earth metal carbonate or alkaline-earth metal hydroxide; and a method according to the fourth embodiment, wherein the oxidizing agent is a material comprising as a primary component at least one of the following materials: alkali metal carbonate, hydrate of alkali metal carbonate, alkali metal hydroxide, alkaline-earth metal carbonate, hydrate of alkaline-earth metal carbonate or alkaline-earth metal hydroxide.

A seventh embodiment is a method according to the third embodiment, wherein the oxidizing agent is a material comprising as a primary component at least one of the following materials: sodium carbonate, potassium carbonate, sodium hydrogen carbonate, potassium hydrogen carbonate, magnesium carbonate, calcium carbonate, hydrate of each of the above carbonates, magnesium hydrate or calcium hydrate, and a method according to the fourth embodiment, wherein the oxidizing agent is a material comprising as a primary component at least one of the following materials: sodium carbonate, potassium carbonate, sodium hydrogen carbonate, potassium hydrogen carbonate, magnesium carbonate, calcium carbonate, hydrate of each of the above carbonates, magnesium hydrate or calcium hydrate.

The method of the present invention can reduce the boron concentration of silicon to 0.3 mass ppm or less, so as to be available for a solar battery, without using expensive equipment such as a plasma device or a gas-blowing device. Further, use of the combination of the present invention and a conventional unidirectional solidification process or a conventional vacuum melting process, can provide silicon available as a raw material for a solar battery with high quality and low cost.

### BRIEF DESCRIPTION OF DRAWINGS

FIG. 1 is a schematic diagram showing the first embodiment of the invention.

FIG. 2 is a schematic diagram showing the second embodiment of the invention.

FIG. 3 is a schematic diagram showing part of the third embodiment of the invention.

FIG. 4 is a schematic diagram showing the third embodiment of the invention.

FIG. 5 is a schematic diagram showing a mechanical way of applying for vacuum pressure used in the invention.

FIG. 6 is a graph showing the relation between rate of vaporization of boron and vacuum pressure.

FIG. 7a is an explanatory diagram providing one illustration of a mixture of slag and oxidizing agent over molten silicon.

FIG. 7b is an explanatory diagram providing another illustration of a mixture of slag and oxidizing agent over molten silicon.

FIG. 7c is an explanatory diagram providing an illustration of oxidizing agent placed on slag over molten silicon.

### PREFERRED EMBODIMENTS OF THE INVENTION

As described above, conventional slag purification technologies can be classified into two categories, i.e., a first category or simple slag purification method where slag only is supplied onto molten silicon; and second category or complex slag purification method where oxidizing gas is used together with the slag. The method of the present invention is characterized in that boron is removed from silicon by performing slag purification under vacuum conditions, which cannot be classified to any of the conventional categories. Although the vacuum melting process mentioned above is known, where impurities such as phosphor are removed by vaporizing from silicon by holding the molten silicon in a vacuum state, the vacuum melting process does not use a slag.

In conventional slag purification, it has been surmised that boron in slag has no additional chemical changes irrespective of its form as elemental boron or boron oxide. On the above premise, the following conclusion is made. That is, comparing the thermodynamic stability between boron (elemental form, oxide form or other boron compound form) in silicon, boron (elemental form, oxide form or other boron compound form) in the slag, and boron compound gas, if the boron compound gas is more stable than boron in silicon, boron can be removed by vaporizing from silicon. On the contrary, if boron in the slag is more stable than boron in silicon, boron migrates from the silicon to the slag. Consequently, when the boron in the silicon migrates to the slag without being vaporized, it is concluded that the boron in the slag is more stable than boron compound gas and thus is much more difficult to vaporize than the boron in the silicon. Since there has been no example reported that boron in silicon is removed from silicon using a vacuum melting process, it has been assumed that boron in slag cannot be vaporized under vacuum state. In view of this, the vacuum treatment of slag has never been carried out.

The present inventors have found that a vaporizable boron compound (a low boiling point material) can be formed in slag when the boron in the slag is chemically changed. In the present invention, the evaporation of the boron compound formed in the slag can be accelerated based on the fact mentioned above, by keeping the slag under a vacuum state. As the boron content in the slag is reduced, as the boron compound in the slag is vaporized, boron in the silicon migrates to the slag according to the boron partition rate. As a result, the boron content in the silicon can be reduced.

Amore specific example is described below. Slag purification is carried out with respect to molten silicon with sodium carbonate thereon which is covered with a slag based on a SiO₂ slag. After boron in silicon migrates to the slag in the form of elemental boron and/or boron oxide, then the elemental boron and/or boron oxide is chemically changed to a boron-containing low boiling point material. Such low boiling point material includes compounds comprising boron and oxygen and/or boron, oxygen and sodium and is characterized by being easily vaporized and removed from the slag. That is, in slag at high temperature, this boron containing low boiling point compound has a much higher vapor pressure than normal boron oxide. Therefore, upon being formed on the surface of the slag, the boron-containing low boiling point material is vaporized. However, since slag is usually highly viscous, the low boiling point material formed in the slag (not on the surface) forms micro bubbles and is hardly separated from the slag. These micro bubbles often contact the molten silicon by slag agitation during the purification process and dissolve in the silicon. Therefore, the rate of boron vaporization from the slag is restrained at atmospheric pressure. In the present invention, keeping the slag under a vacuum state enlarges the bubbles of boron-containing low boiling point material in the slag. Thus, the bubbles of low boiling point material easily reach the surface of the slag and are separated from the slag. As a result, the rate of boron vaporization from the slag increases, which can be expected according to the inherent vapor pressure of the boron-containing low boiling point material. As the pressure around the slag decreases, the collision probability between the vaporized molecules and ambient gas molecules also decreases. Therefore, the rate of vaporization of the low boiling point material from the slag surface increases.

The present inventors have also found that when slag purification is carried out by putting an oxidizing agent such as sodium carbonate directly on molten silicon, a boron partition rate as high as 7-11 can be obtained. High purity silicon with a boron concentration of 0.1 mass ppm or the like can be obtained by using only the effect of removal by vaporization, and can more easily obtained by taking advantage of a high partition rate at the same time.

In a conventional simple slag purification, a great deal of slag is required to perform the purification since boron removal from silicon depends only on the partition rate determined by properties. In particular, when the partition rate is as low as 1 or so, it is theoretically difficult achieve a boron concentration in the silicon lower than that of the slag. In the present invention, since the boron in the slag can be removed by vaporization as a boron compound, there is no lower limitation of boron concentration in the silicon determined by the boron concentration of the slag as mentioned above. Also, the amount of slag required can be relatively small, which is an advantage of the present invention compared to a simple slag purification.

In a conventional complex slag purification, since a special torch is used, there are problems concerning expensive manufacturing facilities in addition to complicated operations. Also, since a great amount of oxidizing gas has to be contacted with the molten silicon, it is another problem to have loss due to oxidized silicon, which lowers the yield. In the present invention, however, only the slag is partly exposed to vacuum pressure, which does not require special facilities or other complicated operations. Loss of oxidized silicon is vanishingly small due to the absence of oxidizing gas. These are some advantages of the present invention compared to conventional complex slag purification.

### Construction of Apparatus

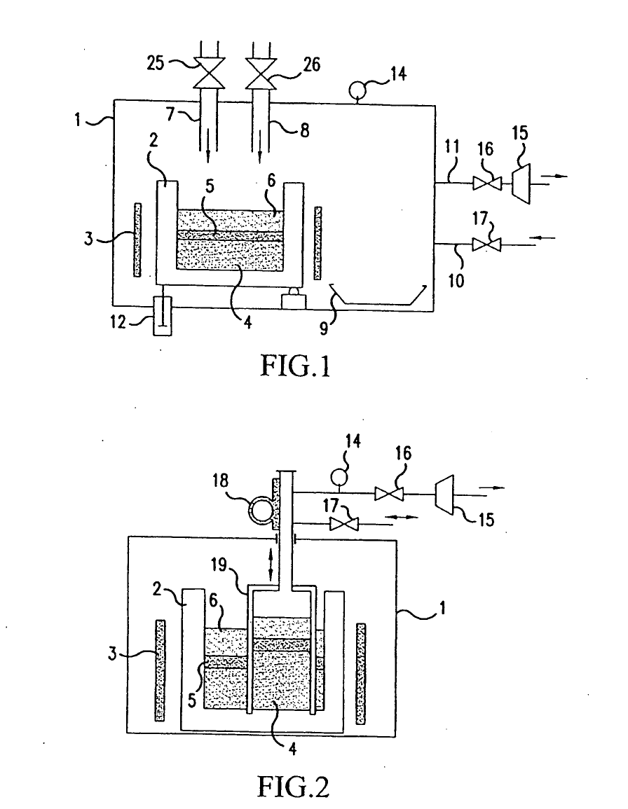

The construction of an apparatus for the first embodiment of the present invention is described below based on FIG. 1. This apparatus is designed to accelerate boron removal by vaporization from slag by keeping a whole purification furnace, including the slag, in a vacuum state. A crucible 2, placed in a purification furnace 1, is heated by a heater 3. Molten silicon 4 is accommodated in the crucible 2 and kept at a certain temperature. An oxidizing agent 5 is fed through an oxidizing agent feeding tube 7, and slag 6 is fed through a slag feeding tube 8 to the molten silicon 4 in the crucible 2. A reaction and purification, including boron removal, is commenced between the molten silicon 4, the oxidizing agent 5 and the slag 6. After feeding of the oxidizing agent 5 and the slag 6, a flow valve 17 of a gas feeding tube 10 is closed and a vacuum valve 16 of a gas exhaust tube 11 is opened. Then, a vacuum pump 15 is turned on to evacuate gas inside the purification furnace 1. In this state, purification is carried out and the pressure inside the furnace is maintained at a preferable value by controlling the vacuum pump while monitoring a pressure gauge 14. When the oxidizing agent 5 is consumed (by reaction with molten silicon 4 and slag 6 or by vaporization) and boron migration to the slag 6 is almost completed, the vacuum pump 15 is turned off, the vacuum valve 16 is closed and the flow valve 17 is opened to return the inside pressure of the furnace back to atmospheric pressure. The slag and the oxidizing agent remaining on the molten silicon 4 are discharged from the crucible 2 by tilting the crucible 2 using a crucible tilting device 12 into a waste slag receiver 9. Then the crucible 2 is set to the original position and, if necessary, slag 6 and oxidizing agent 5 are again fed onto the molten silicon 4 and the purification process is repeated.

The construction of an apparatus for the second embodiment of the present invention is described below based on FIG. 2. This apparatus is designed to accelerate the removal of boron from slag by vaporizing boron compounds by keeping a part of the slag exposed to vacuum pressure. The basic construction and operation is the same as that in FIG. 1. In FIG. 2, parts common to the parts in FIG. 1 are omitted and structure/mechanism by which only the slag-including portion is exposed to vacuum pressure is mainly disclosed. Only differences from FIG. 1 are described. Referring to FIG. 2, a vacuum cup 19 is located above the crucible 2 in which molten silicon 4, an oxidizing agent 5 and slag 6 are layered from the bottom in turn at atmospheric pressure. The vacuum cup 19 is lowered by an up-and-down mechanism 18 to be placed into the slag. Then the flow valve 17 is closed, the vacuum valve 16 is opened, and the vacuum pump 15 is turned on to evacuate a gas inside the vacuum cup 19. Only a limited portion of the slag 6 is exposed to vacuum pressure and the remainder inside the furnace stays at atmospheric pressure. The pressure inside the vacuum cup 19 is monitored by a pressure gauge 14 and the vacuum pump 15 is controlled to maintain the appropriate pressure inside the cup. When the oxidizing agent is consumed and boron migration to the slag 6 is almost completed, the vacuum pump 15 is turned off, the vacuum valve 16 is closed and the flow valve 17 is opened to return the inside pressure of the vacuum cup 19 to atmospheric pressure. Then, if necessary, the slag in the vacuum cup 19 is replaced with new slag around the cup and the same vacuum process is repeated. The slag discharging process is the same as that described with respect to FIG. 1. The vacuum cup 19 can be made of SiC-coated carbon fiber-reinforced carbon having both pressure and corrosion resistance. In the case where the bottom part of the vacuum cup 19 is not attached to the bottom of the crucible, the level of slag and molten silicon is raised inside the vacuum cup 19 during the vacuum process, and the fluid level outside the vacuum cup 19 is lowered. If the horizontal cross-sectional area of the vacuum cup 19 is relatively large compared to the horizontal cross-sectional area of the crucible, all of the material outside the vacuum cup is swallowed into the vacuum cup, which can present problems. In view of this, the horizontal cross-sectional area of the vacuum cup is preferably one-fourth or less of the horizontal cross sectional of the crucible. In the case where the bottom part of the vacuum cup 19 is firmly attached to the bottom of the crucible, the material outside the vacuum cup has very little flow into the vacuum cup. Thus, in this instance, the cross sectional area of the cup can be the same or less of that of the crucible. Since the purification rate of boron increases as the cross-sectional area of the vacuum cup increases, the cross-sectional area of the vacuum cup is preferably one-tenth or more of the cross sectional area of the crucible.

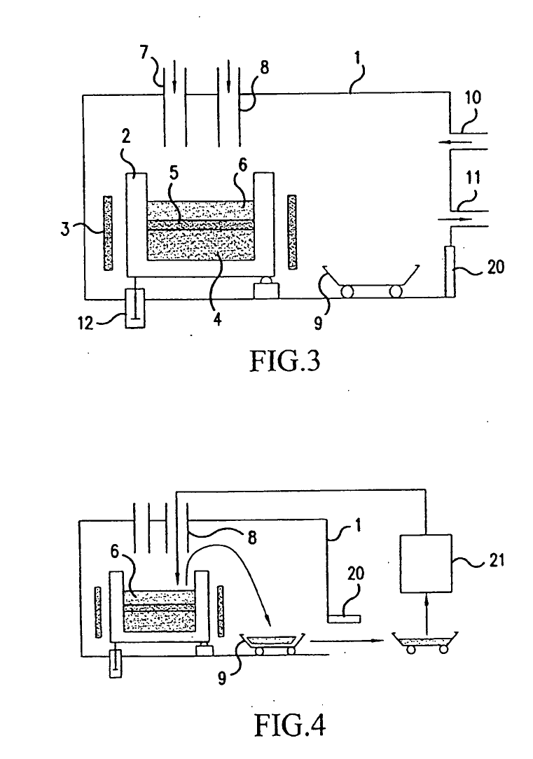

For the third embodiment of the present invention, a way where only the slag is independently vacuum-processed is described. The examples illustrated by FIG. 1 and FIG. 2 concern processes where either the entire furnace is kept under vacuum pressure or where a vacuum cup fixed to up-and-down mechanism is used inside the purification furnace. However, if the slag is separated from the silicon, then the slag can be much more easily vacuum-processed. This process is explained by referencing FIG. 3 and FIG. 4. First, purification of silicon is performed using a heating furnace of FIG. 3 where the inside contains argon gas at atmospheric pressure, and other conditions are the same as that in the embodiment using FIG. 1. Second, slag discharged into the waste slag receiver 9 is transported outside of the furnace through a door 20 in the purification furnace 1. Third, the slag together with the waste slag receiver 9 is placed in a vacuum heating furnace 21 and exposed to vacuum pressure while being heated. The vacuum heating furnace 21 can be much smaller than the purification furnace 1 since the furnace 21 is only for a small amount of slag. Fourth, after boron compounds in the slag have been sufficiently vaporized, the slag together with the waste slag receiver 9 is pulled out of the vacuum heating furnace 21. Then, slag is again fed through the slag feeding tube of the purification furnace 1 used in the previous stage together with an oxidizing agent onto the molten silicon, which was already purified once in the previous stage. Then, the same process as that described in the embodiment using FIG. 1 is performed. In this case, the vacuum facilities can be very compact since only a small vacuum heating furnace 21 is required.

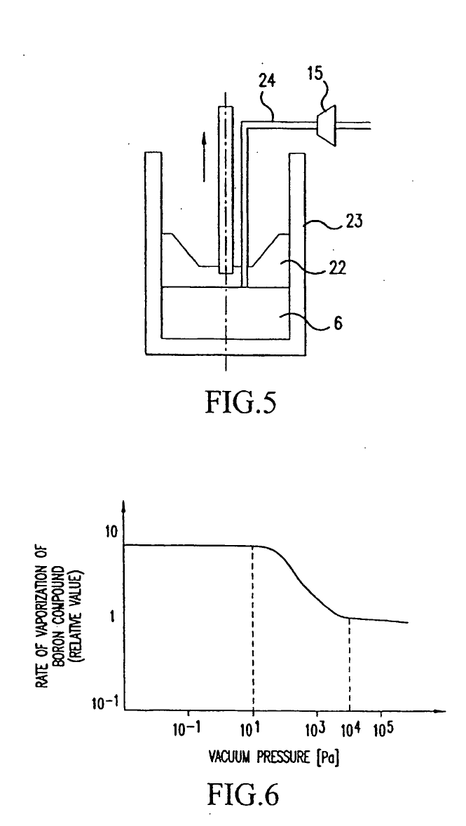

As another method for exposing the slag to vacuum pressure, a more mechanical way can be applied. For example, a piston-cylinder mechanism shown in FIG. 5 can be used. Melted slag 6 is filled in the bottom of a cylinder 23 and a piston 22 is inserted so as to completely contact the slag 6. Then, the piston 22 is pulled up using an actuator (not shown) to provide vacuum pressure inside the slag 6. Since the slag is in a fluid state, the inside of the slag can averagely be subjected to negative pressure (absolute pressure). If sufficient power is provided to the piston, this leads to a very effective vacuum pressure. Gas generated from the slag 6 is exhausted by a vacuum pump to the outside through an exhaust tube 24 passing through the piston 22 so that the piston 22 can be kept in contact with the slag 6.

Oxidizing agents: As for oxidizing agents, any oxidizing agents can be used as long as they meet conditions concerning oxidizing ability, purity, ease of handling and price. Preferably, however, the oxidizing agent is a material comprising as a primary component at least one of the following materials: alkali metal carbonate, hydrate of alkali metal carbonate, alkali metal hydroxide, alkaline-earth metal carbonate, hydrate of alkaline-earth metal carbonate or alkaline-earth metal hydroxide. There are several reasons why these materials are preferred. First, they have a large oxidizing ability. Second, they contribute very little to contamination of the silicon by dissolving in the silicon. Third, they possess the property of stable slag formation with low melting point and low viscosity by reacting with the slag, which can make it easy to handle them with respect to exhaust and waste treatment. Fourth, they have the ability to accelerate formation of boron compounds which are easily vaporizable in the slag. More preferably, the oxidizing agent is a material comprising as a primary component at least one of the following materials: sodium carbonate, potassium carbonate, sodium hydrogen carbonate, potassium hydrogen carbonate, magnesium carbonate, calcium carbonate, hydrate of each of the above carbonates, magnesium hydrate or calcium hydrate. There are several reasons why these materials are more preferred. First, these materials have the ability to form a SiO₂ film on the surface of the molten silicon, which inhibits contact between the molten silicon and the slag, and these materials form slag and are removed with the slag. Second, these materials are mass-produced goods and high purity products are surely obtained. The alkaline-earth metals mentioned above include beryllium and magnesium.

Slag: As for slag, SiO₂, such as high purity silica sand without silicon contamination or Al₂O₃, such as high purity alumina, are preferred base materials. It is also preferable to add sodium carbonate or the like to the slag in advance in order to change boron to boron compounds which are easily vaporized, or to feed sodium carbonate or the like to the molten silicon separately from the slag to chemically change the boron in the slag. As described later, since it is preferable to operate the purification at a temperature close to the melting point of silicon, it is also desirable to intend to lower the melting point and the viscosity of the slag. Since sodium carbonate is capable of lowering the viscosity of the slag, it can be independently added to SiO₂. Or, it is also possible to add additives other than oxidizing agents. Such additives may include CaO, to achieve a milder reaction rate for purification. As for the slag, commercially available high purity soda glass can be used after being crushed and heated. As for the temperature of the slag, it should preferably be 2000° C. or less in view of the desire to prevent silicon contamination and/or an excessive reaction rate.

Slag, oxidizing agent feeding operation: There are two preferable ways for the slag to be fed. In the first way, raw slag material is mixed and heated to form a molten material or glass state material, which is then fed to the molten silicon. In the second way, raw slag material is processed to form a granular solid and then fed separately from an oxidizing agent. The grain size of the granular solid preferably ranges from 1 mm to 200 mm in view of anti-scattering and/or operationability.

As for the oxidizing agent, soda ash or the like, a commercially available granular material, can be used without problems. As for the grain size, it preferably ranges from 1 mm to 50 mm in view of reactivity and feeding operationability. If a strong reaction can be allowed, it is possible to increase the reaction rate by feeding molten oxidizing agent directly on the molten silicon after heating the oxidizing agent in advance to a temperature slightly higher than the melting point. It should be noted, however, that the oxidizing agent are preferably be fed at a temperature under its decomposing temperature since a majority of alkali carbonates are decomposed/vaporized at a temperature of more than 1000° C.

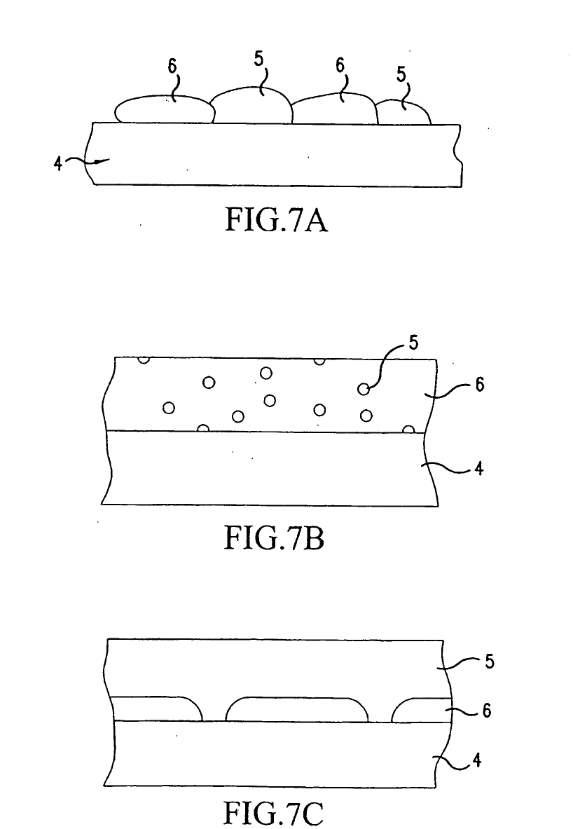

As for the positional relation between the fed slag and the fed oxidizing agent on the molten silicon, it is preferable to place the oxidizing agent directly on the molten silicon. Since the boron in the molten silicon can be mainly oxidized by direct contact with the oxidizing agent, the contact area between the molten silicon and the oxidizing agent is preferably as large as possible. Enlarging the contact area by stirring the molten silicon can increase the boron oxidization rate. It has been found by the present inventors that boron in the molten silicon is mainly oxidized by direct contact with the oxidizing agent and then immediately absorbed in the slag as boron oxide. This provides a high partition rate of boron. If lowering of the reaction rate is needed because the reaction rate is too fast for the operation, it is not necessary to place the oxidizing agent under the slag. Rather, the oxidizing agent may be fed so as to be mixed with the slag (as shown in FIG. 7a and FIG. 7b) or placed on the slag (as shown in FIG. 7c).

The slag and oxidizing agent being fed together means that the slag and oxidizing agent fed within a short time interval. Feeding within a short time interval means, for example, that the slag is fed before a majority of the oxidizing agent is consumed (due to reaction with the molten silicon and/or decomposition/vaporization under high temperature). More specifically, for example, there is no problem if the feeding of the slag starts within 20 minutes after the oxidizing agent of tens of kg is initially fed.

Atmosphere of operation: In conventional technologies, since the boron concentration in the slag after purification reaches an equilibrium concentration with that in the molten silicon, it can be difficult to reuse the used slag for another silicon purification. In the present invention, increased boron in the slag can be removed from the slag by vaporization by exposing the slag to vacuum pressure. This makes it possible to reuse the used slag and leads to a reduction in the total amount of slag to be used and a reduction in manufacturing cost. The conditions of the atmosphere of the operation without evacuation are as follows: A reducing atmosphere, such as hydrogen gas, should be avoided so as to not inhibit the oxidization of boron in the molten silicon. In the case where graphite is used as a crucible and/or a refractory lining, an oxidizing atmosphere, such as air should be avoided in order to avoid the deterioration of the crucible and/or refractory lining by oxidization. Therefore, an inert gas atmosphere, such as an argon gas atmosphere is preferred.

The conditions of the atmosphere of operation with evacuation are as follows: Generally, argon gas is preferable as an atmospheric gas. If the pressure of the operation is 100 Pa or less, air can be available since the influence by the air is negligible. The pressure of the atmosphere of operation preferably ranges from 10 to 10,000 Pa. If the pressure exceeds 10,000 Pa, the rate of vaporization of boron can be lowered. However, there is still some effect remaining at a pressure exceeding 10,000 Pa, so a pressure slightly over 10,000 Pa may be used for some reasons with respect to the facilities. At 10 Pa, increase of the rate of vaporization of boron is saturated. Obviously there is no problem in using a pressure less than 10 Pa as to rate of vaporization. However, a special type vacuum pump is required to maintain such a low pressure, which leads to an increase in the cost of the plant. Also, such low pressure applied when the molten silicon and slag are contacted results in an acceleration of the reaction between Si and SiO₂ to generate a great amount of SiO gas, which leads to a very low percentage yield of silicon. Therefore, operation under 10 Pa is preferably avoided.

Other operation conditions: As for the crucible to be used, stability against molten silicon and oxidizing agents is desired. For example, graphite and/or alumina can be used. A crucible of which the primary material is SiO₂ can be used in order to take advantage of elution of crucible material as a part of raw material for the slag.

As for the operation temperature, a high temperature operation is preferably avoided as much as possible in view of durability and contamination of the refractory lining. The temperature of the molten silicon is preferably between the melting point of silicon and 2000° C. The temperature of the silicon obviously has to be at the temperature of the melting point of silicon or higher.

### EXAMPLES

### Example 1

A furnace as shown in FIG. 1, which is a modification of a general vacuum heating furnace, is used as a purification furnace for purifying silicon. 50 kg of metal silicon grain, of which the boron concentration is 12 mass ppm and of which the average diameter is 5 mm, is accommodated in the graphite crucible of 500 mm diameter placed in the purification furnace. The crucible is heated to 1500° C. in an argon atmosphere and the resulting molten silicon is maintained. In a second heating furnace, a mixture of 20 kg of high purity silica sand, of which the boron concentration is 1.5 mass ppm and of which the average diameter is 10 mm, and 5 kg of powdered sodium carbonate (Na₂CO₃), of which the boron concentration is 0.3 mass ppm, is accommodated in a graphite crucible and heated to and maintained at 1600° C. to form a slag. Then, 15 kg of powdered sodium carbonate (Na₂CO₃), of which the boron concentration is 0.3 mass ppm, is fed onto the molten silicon in the purification furnace through an oxidizing agent feeding tube, and the slag prepared in the second heating furnace is transported together with the crucible to the purification furnace and the crucible is tilted to feed the slag onto the molten silicon through a slag feeding tube. The time from feeding the oxidizing agent to feeding the slag is about 5 minutes. After finishing the feeding of the slag, the purification furnace is sealed and evacuated by a vane type vacuum pump until pressure inside the furnace reaches 1000 Pa. The temperature of the molten silicon is maintained at 1500° C. and purification is carried out for 30 minutes. During the purification, gas inside the furnace is sampled and analyzed to find that the majority of the gas containing Na inside the furnace is in the boron-containing low boiling point material, for example, as a compound comprising boron and oxygen and/or boron, oxygen and sodium. After finishing the purification, turning off the vane type vacuum pump and returning the atmosphere inside the furnace to initial argon atmospheric pressure, the crucible is tilted to discharge the slag and remaining oxidizing agent into the waste slag receiver and the molten silicon is sampled. The sampling is made as follows: One end of a high purity alumina tube, which is heated to a temperature greater than the melting point of silicon, is dipped into the molten silicon, and the molten silicon is sucked through the tube. Solidified silicon formed by quenching at a non-heated portion of the tube is carried out of the furnace and the solidified silicon is separated from the alumina tube as a sample to be analyzed. The weight of the sample is about 100 g. The method of component analysis of the sample is Inductively Coupled Plasma (ICP) analysis, a method which is widely used in the industry. Then, the oxidizing agent and the slag are again fed onto the molten silicon to repeat the purification at the same vacuum pressure. A total of three purifications are carried out. The boron concentration of the finally obtained sample is 0.09 mass ppm, which satisfies the boron concentration requirements of silicon intended for solar batteries.

### Example 2

A furnace as shown in FIG. 2, which is a modification of a general vacuum heating furnace, is used as a purification furnace for purifying silicon. The vacuum cup made of SiC-coated carbon fiber-reinforced carbon, of which diameter is 300 mm and height is 1 m, is coupled to an air cylinder located outside the furnace so that the vacuum cap can be moved up and down by operating the air cylinder. The same crucible, same silicon raw material and same slag are prepared and the oxidizing agent and the slag are fed onto the molten silicon in the same way as in Example 1. After the vacuum cup is moved down to firmly attach to the bottom of the crucible and fixed, a vane type vacuum pump connected to the vacuum cup through a tube is turned on to evacuate the inside of the vacuum cup to a pressure of 10,000 Pa. In these conditions, the purification of silicon is performed with keeping the temperature of the molten silicon at 1500° C. for 30 minutes. After finishing the purification, turning off the vane type vacuum pump and returning the atmosphere inside the vacuum cup to initial argon atmospheric pressure, the vacuum cup is moved up to be detached from the slag. Then the crucible is tilted to discharge the slag and remaining oxidizing agent into the waste slag receiver and the molten silicon is sampled. The sampling is made in the same way as in Example 1. Then, the oxidizing agent and the slag are fed again onto the molten silicon to repeat the purification at the same vacuum pressure. A total of three purifications are carried out. The boron concentration of the finally obtained sample is 0.10 mass ppm, which satisfies the boron concentration requirements of silicon intended for solar batteries.

### Example 3

A furnace as shown in FIG. 3, which is a modification of a general vacuum heating furnace, is used as a purification furnace for purifying silicon. The same crucible, same silicon raw material and same slag are prepared and the oxidizing agent and the slag are fed onto the molten silicon in the same way as in Example 1. The purification of silicon is performed under an argon atmospheric pressure and the temperature of the molten silicon is maintained at 1500° C. for 20 minutes. Then, the crucible is tilted to discharge the slag into the waste slag receiver and the slag in the waste slag receiver is carried out of the furnace to be put in another small sized vacuum heating furnace. The small sized vacuum heating furnace, of which inside volume is 1 m³, has a general structure equipped with resistance heating and connected to a vane type vacuum pump. After the slag is maintained at 1500° C. for 20 minutes under a vacuum pressure of 100 Pa in the small size vacuum heating furnace, the slag is fed again together with an oxidizing agent onto the molten silicon previously purified in the furnace. The same purification operation is repeated three times altogether. The boron concentration of the finally obtained sample is 0.12 mass ppm, which satisfies the boron concentration requirements of silicon intended for solar batteries.

### Example 4

In this example, all parameters are the same as that in Example 1, except MgCO₃ is used as an oxidizing agent. The boron concentration of the finally obtained sample is 0.2 mass ppm, which satisfies the boron concentration requirements of silicon intended for solar batteries.

All cited patents, publications, copending applications, and provisional applications referred to in this application are herein incorporated by reference.

The invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for producing high purity silicon, comprising:
preparing molten silicon;
preparing a slag;
bringing the molten silicon and the slag into contact with each other; and
exposing at least the slag to vacuum pressure.

2. The method according to claim 1, further comprising:
providing an oxidizing agent together with the slag to the molten silicon.

3. The method according to claim 2, wherein the oxidizing agent is provided so as to directly contact the molten silicon.

4. The method according to claim 1, wherein the vacuum pressure ranges from 10 Pa to 10,000 Pa.

5. The method according to claim 2, wherein the oxidizing agent is a material comprising as a primary component at least one material selected from the group consisting of alkali metal carbonate, hydrate of alkali metal carbonate, alkali metal hydroxide, alkaline-earth metal carbonate, hydrate of alkaline-earth metal carbonate and alkaline-earth metal hydroxide.

6. The method according to claim 3, wherein the oxidizing agent is a material comprising as a primary component at least one material selected from the group consisting of alkali metal carbonate, hydrate of alkali metal carbonate, alkali metal hydroxide, alkaline-earth metal carbonate, hydrate of alkaline-earth metal carbonate and alkaline-earth metal hydroxide.

7. The method according to claim 2, wherein the oxidizing agent is a material comprising as a primary component at least one material selected from the group consisting of sodium carbonate, potassium carbonate, sodium hydrogen carbonate, potassium hydrogen carbonate, magnesium carbonate, calcium carbonate, hydrate of each of the above carbonates, magnesium hydrate and calcium hydrate.

8. The method according to claim 3, wherein the oxidizing agent is a material comprising as a primary component at least one material selected from the group consisting of sodium carbonate, potassium carbonate, sodium hydrogen carbonate, potassium hydrogen carbonate, magnesium carbonate, calcium carbonate, hydrate of each of the above carbonates, magnesium hydrate and calcium hydrate.

9. A method for producing high purity silicon, comprising:
preparing molten silicon;
preparing a slag;
bringing the molten silicon and the slag into contact with each other;
separating the slag from the molten silicon;
exposing the slag be exposed to vacuum pressure; and
bringing the molten silicon and the slag exposed to vacuum pressure into contact with each other.

10. The method according to claim 9, further comprising:
providing an oxidizing agent together with the slag to the molten silicon.

11. The method according to claim 10, wherein the oxidizing agent is provided so as to directly contact the molten silicon.

12. The method according to claim 9, wherein the vacuum pressure ranges from 10 Pa to 10,000 Pa.

13. The method according to claim 10, wherein the oxidizing agent is a material comprising as a primary component at least one material selected from the group consisting of alkali metal carbonate, hydrate of alkali metal carbonate, alkali metal hydroxide, alkaline-earth metal carbonate, hydrate of alkaline-earth metal carbonate and alkaline-earth metal hydroxide.

14. The method according to claim 11, wherein the oxidizing agent is a material comprising as a primary component at least one material selected from the group consisting of alkali metal carbonate, hydrate of alkali metal carbonate, alkali metal hydroxide, alkaline-earth metal carbonate, hydrate of alkaline-earth metal carbonate and alkaline-earth metal hydroxide.

15. The method according to claim 10, wherein the oxidizing agent is a material comprising as a primary component at least one material selected from the group consisting of sodium carbonate, potassium carbonate, sodium hydrogen carbonate, potassium hydrogen carbonate, magnesium carbonate, calcium carbonate, hydrate of each of the above carbonates, magnesium hydrate and calcium hydrate.

16. The method according to claim 11, wherein the oxidizing agent is a material comprising as a primary component at least one material selected from the group consisting of sodium carbonate, potassium carbonate, sodium hydrogen carbonate, potassium hydrogen carbonate, magnesium carbonate, calcium carbonate, hydrate of each of the above carbonates, magnesium hydrate and calcium hydrate.
